(19) United States
(12) Patent Application Publication
(10) Pub. No.: US 2013/0006873 A1
(43) Pub. Date: Jan. 3, 2013

(54) METHOD OF CREATING AND MANAGING SIGNATURE PAGES

(76) Inventor: Edwin Hermawan, Los Angeles, CA (US)

(21) Appl. No.: 13/170,465

(22) Filed: Jun. 28, 2011

(51) Int. Cl. G06Q 10/00; G06Q 50/00

(52) U.S. Cl. 705/80

(57) ABSTRACT

A computer implemented method of managing signatures includes receiving, via a computing device, signatory information from a user related to a signatory and an agreement identifier identifying a specific agreement from a plurality of agreements. Via the computing device, a signature page associated with the specific agreement is sent to the signatory. The signature page is received, via the computing device, including a signature of the signatory. The signature of the signatory may be verified visually by the user. A positive or negative verification of the signature may be stored via the computing device. A status may be displayed including an indication of the signature page being sent, received, signed or incomplete. The agreements may be organized based upon the agreement identifier, a company name or the signatory. A collaborator may be invited, via the computing device, to identify a specific individual associated with the signatory.

### FIELD OF THE INVENTION

The present invention generally relates to physically signing contracts and agreements between multiple parties. More particularly, the present invention relates to a computer implemented method of creating and managing physical signatures on signature pages associated with a related agreement.

### BACKGROUND OF THE INVENTION

Almost everyone in the civilized world has at one point been presented with a document for signing. By signing an agreement, it certifies that a binding agreement has been entered into by and between the parties. The signature is verification that the party entered into the agreement and the agreement itself spells out the terms of that agreement. This process is usually very simple when the parties are few in number and the agreement is short in length. However, corporate transactions account for a large portion of executed agreements and many corporate transactions are far from simple.

Corporate transactions can easily become very complicated as there are numerous signatories each associated with a different company and firm as well as multiple documents associated with each transaction. Typically in corporate transactions, once the agreements have been fully negotiated and agreed upon, parties send one another only the pages of the agreement requiring the signature. Managing the vast network of signatures to be collected can become a fulltime job, especially considering when some organizations deal with corporate transactions on a regular basis. It is extremely hard and time consuming to effectively manage these signatures. Unfortunately, there is not a more cost effective and efficient approach to dealing with these signatures available today.

Typically, an employee manually creates a signature page on a computer in a word processing software, such as Microsoft Word. The employee also creates the language of the signature page as part of the agreement and spends a lot of time appropriately formatting the text, adding in names and relevant information and also creating signature blocks for signing. This process is extremely tedious and time consuming.

Once a signature page is generated, it must then be mailed out to the respective parties. Once a receiving party obtains the agreement, they sign and send it back. Once again it is up to the employee to collect all the incoming signed signature pages and properly collate them, verify they are indeed signed, and then place and categorize them into the appropriate file or folder. Current protocol is to send signature pages as attachments in an email to the appropriate parties. This process works well for simple agreements where there are few agreements and the signing parties are relatively few.

Unfortunately, corporate transactions work on a much quicker and sporadic timeline. To speed up the process, the agreement itself and the signature page are better managed if they are not one in the same. The agreement may be negotiated at a different time or location, the agreement may already be finished, or a multitude of agreements may be ready for the choosing. Also, different parties will want to accept the agreement at different times. With corporate transactions, there may be a multitude of signatures required from a multitude of parties. Currently available software and applications are not suited for this type of business practice and methods.

Accordingly, there is a need for a method of creating and managing physical signatures on signature pages which are separate but associated with a related agreement. The need extends to managing a multitude of signatures pages related to a multitude of related agreements which are sent to a multitude of recipients. The present invention fulfills these needs and provides other related advantages.

### SUMMARY OF THE INVENTION

An exemplary embodiment of the present invention includes a computer implemented method of managing signatures. The method includes receiving, via a computing device, signatory information from a user related to a signatory and an agreement identifier. The agreement identifier identifies a specific agreement from a plurality of agreements. The method includes sending, via the computing device, a signature page to the signatory. The signature page is associated with the specific agreement through the agreement identifier. The method includes receiving, via the computing device, the signature page comprising a signature of the signatory. The signature page and specific agreement are separate documents.

The method includes the step of displaying, via the computing device, a status of the specific agreement. The status may include an indication of the signature page sent, an indication of the signature page received, an incompletion of the signature of the signatory or a completion of the signature of the signatory. The method may also include the step of organizing, via the computing device, the specific agreement from the plurality of agreements based upon the agreement identifier, a company name or the at least one signatory. This way it is easy for the user to organize, via the computing device, relevant information relating to the specific agreement. Follow up actions can quickly be identified and carried out such as recontacting the signatory, sending out follow up signatory pages, or other various actions based upon the status of the signature.

Another exemplary embodiment of the method may include verifying, via the computing device, the signature of the signatory on the signature page. The step of verifying the signature of the signatory on the signature page may include visually verifying the signature by the user. The method may also include the step of storing, via the computing device, a positive or negative verification of the signature of the signatory on the signature page.

Another exemplary embodiment of the method may include inviting, via the computing device, a collaborator associated with the signatory. The method may include allowing, via the computing device, the collaborator to identify a specific individual associated with the signatory.

The computing device may include a webpage connected to the Internet. The step of sending and receiving of the signature page via the computing device may include email. The signatory information may include a specific individual associated with the signatory and a company name associated with the signatory. The signatory may include a plurality of signatories. The signature page may include a plurality of signature pages each associated with the specific agreement through the agreement identifier.

Another exemplary embodiment of the method may include generating, via the computing device, the signature page from a premade template and the signatory information. Alternatively, the method may include uploading, via the computing device, the signature page including a premade signature page. The signature of the signatory may include a physical signature.

Another exemplary embodiment of the present invention includes a computer implemented method of managing signatures. The method includes receiving, via a computing device, signatory information from a user related to at least one signatory and an agreement identifier. The agreement identifier identifies a specific agreement from a plurality of agreements. The method includes generating, via the computing device, the signature page from a premade template and the signatory information, where the signature page and the specific agreement are separate documents. The method includes sending, via the computing device, a signature page to the at least one signatory, where the signature page is associated with the specific agreement through the agreement identifier. The method includes receiving, via the computing device, the signature page including a physical signature of the at least one signatory.

Another exemplary embodiment of the method may include verifying, via the computing device, the physical signature of the at least one signatory on the signature page. The step of verifying the physical signature of the at least one signatory on the signature page may include visually verifying the signature by the user. The method may include storing, via the computing device, a positive or negative verification of the physical signature of the at least one signatory on the signature page.

Another exemplary embodiment of the method may include inviting, via the computing device, a collaborator associated with the at least one signatory. The method may include allowing, via the computing device, the collaborator to identify a specific individual associated with the at least one signatory.

Another exemplary embodiment of the method may include displaying, via the computing device, a status of the specific agreement. The status may include an indication of the signature page sent, an indication of the signature page received, an incompletion of the physical signature of the at least one signatory or a completion of the physical signature of the at least one signatory.

Another exemplary embodiment of the method may include organizing, via the computing device, the specific agreement from the plurality of agreements based upon the agreement identifier, a company name or the at least one signatory.

Another exemplary embodiment of the present invention includes a computer implemented method of managing signatures. The method includes receiving, via a computing device, signatory information from a user related to at least one signatory and an agreement identifier, where the agreement identifier identifies a specific agreement from a plurality of agreements. The method includes sending, via the computing device, a signature page to the at least one signatory, where the signature page is associated with the specific agreement through the agreement identifier. The method includes receiving, via the computing device, the signature page including a signature of the at least one signatory. The method includes verifying, via the computing device, the signature of the at least one signatory on the signature page by visually verifying the signature by the user. The method includes storing, via the computing device, a positive or negative verification of the signature of the at least one signatory on the signature page.

Another exemplary embodiment of the method may include inviting, via the computing device, a collaborator associated with the at least one signatory. The method may include allowing, via the computing device, the collaborator to identify a specific individual associated with the at least one signatory.

Another exemplary embodiment may include generating, via the computing device, the signature page from a premade template and the signatory information. Alternatively, the method may include uploading, via the computing device, the signature page comprising a premade signature page. Also, the signature of the at least one signatory may include a physical signature.

Another exemplary embodiment of the method may include displaying, via the computing device, a status of the specific agreement. The status may include an indication of the signature page sent, an indication of the signature page received, an incompletion of the physical signature of the at least one signatory or a completion of the physical signature of the at least one signatory.

Another exemplary embodiment of the method may include organizing, via the computing device, the specific agreement from the plurality of agreements based upon the agreement identifier, a company name or the at least one signatory.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic view of a prior art agreement with signatory section;

FIG. 2 is a schematic view of an exemplary signature page management program embodying the present invention;

FIG. 3 is a screenshot of a login page of an exemplary signature page management program embodying the present invention;

FIG. 4 is a screenshot of an exemplary jobs page of the embodiment of FIG. 1;

FIG. 5 is a screenshot of an exemplary view page of the embodiment of FIG. 1;

FIG. 6 is a screenshot of an exemplary edit page of the embodiment of FIG. 1;

FIG. 7 is a screenshot of an exemplary send page of the embodiment of FIG. 1;

FIG. 8 is a screenshot of an exemplary invite collaborator page of the embodiment of FIG. 1;

FIG. 9 is a screenshot of an exemplary rename page of the embodiment of FIG. 1;

FIG. 10 is a screenshot of an exemplary upload signature page of the embodiment of FIG. 1;

FIG. 11 is a screenshot of an exemplary check signature page of the embodiment of FIG. 1; and

FIG. 12 is a screenshot of an exemplary check page of the embodiment of FIG. 1.

### DETAILED DESCRIPTION OF THE PREFERRED EMBODIMENTS

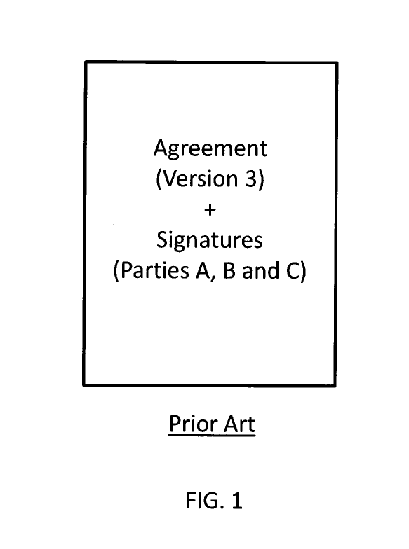

FIG. 1 is a schematic view of the prior art where an agreement and signatories are captured within the extent of a single document. In FIG. 1, the agreement is a hypothetical Version 3 where Parties A, B and C have accepted and signed. It is common practice to tie the signatory section of an agreement to the agreement itself. However, this does not work well with complicated agreements undergoing substantial revisions and variation being negotiated by and with a multitude of parties. It quickly becomes very difficult to keep track of which agreement has or is being accepted and whether all the parties have accepted that agreement.

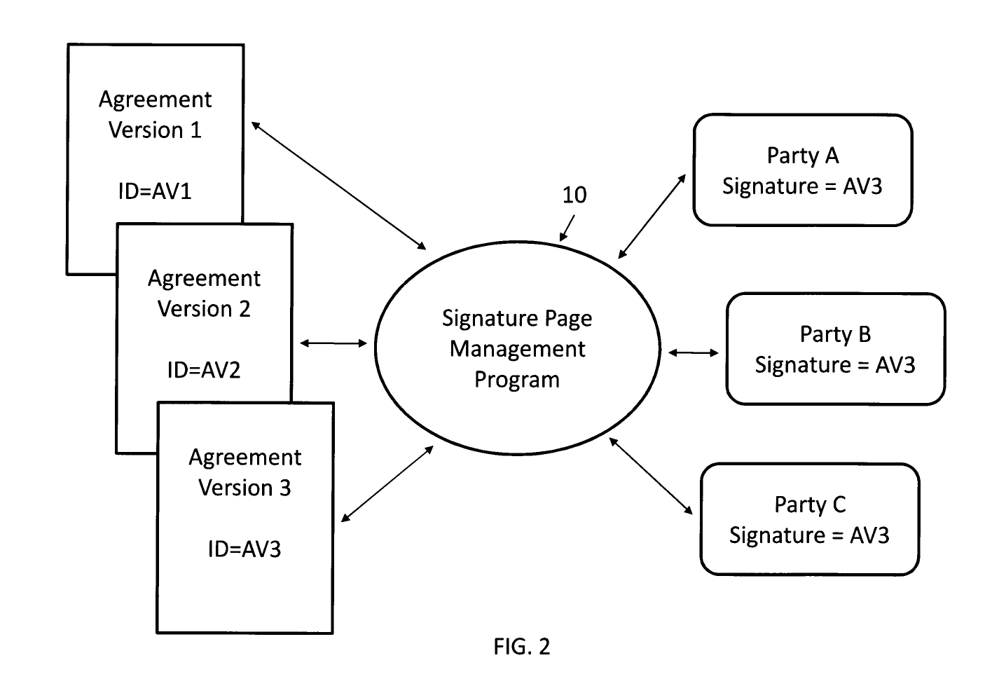

FIG. 2 is a schematic view of an exemplary signature page management program 10 embodying the present invention. Now, the signature page/portion is removed from the agreement itself. Here, there are three different agreements being considered by three different parties. Each agreement or version of agreement is assigned an identifier. For example, Agreement Version 1 has an identifier of AV1. This way Parties A, B and C can create a multitude of different versions during negotiation, or can choose from a variety of premade agreements. Then the Parties can accept a specific version by accessing the signature page management program 10. Here, the Parties have all accepted Version 3 of the agreement.

As can be seen by one skilled in the art, the signature page management program 10 is extremely helpful in allowing a large number of parties to negotiate and accept a specific agreement from a multitude of agreements. The signature page management program 10 reduces the man hours needed to keep track of complicated transactions while reducing errors and speeding up efficiency. The closest available alternative in the marketplace deals with only with managing one document to single or multiple recipients. The present invention is able to manage multiple documents to multiple recipients, organize the status of the signatures of each document, and easily and quickly report the results or status (acceptance) of each signatory.

The identifier can be a multitude of identifiers easily used to identify a specific agreement. For example, the identifier can be an assigned string of numbers or letters or be a specific agreement name. As can be seen by one skilled in the art, this disclosure is not intended to limit the identifier to any specific form or described herein.

In the prior art, an attorney or employee would take a signature page from a previous transaction and have to then adopt it to the current transaction. This would involve manually changing all the names, footers, headers and relevant text. The exemplary signature page management program 10 also allows a user to enter in all the essential data into a central data field and then allow the program 10 to generate a template signature page. This dramatically decreases the time required to generate a multitude of signature pages.

Furthermore, the generated template signature page can then be related by the program 10 to a specific agreement. The program 10 can automatically track each signature page being sent and to which recipient. The program 10 can then track which recipient has received the signature page, which recipient has sent it back, and then which signatures have been verified either automatically or visually by the user. The program 10 can then list which signatures are still outstanding and other relevant information. Previously, attorneys or employees would have to manually keep track of which signature pages came in and what the status was. As can be seen by one skilled in the art, manually organizing such an extensive and confusing process is prone to failure, errors and inconsistencies.

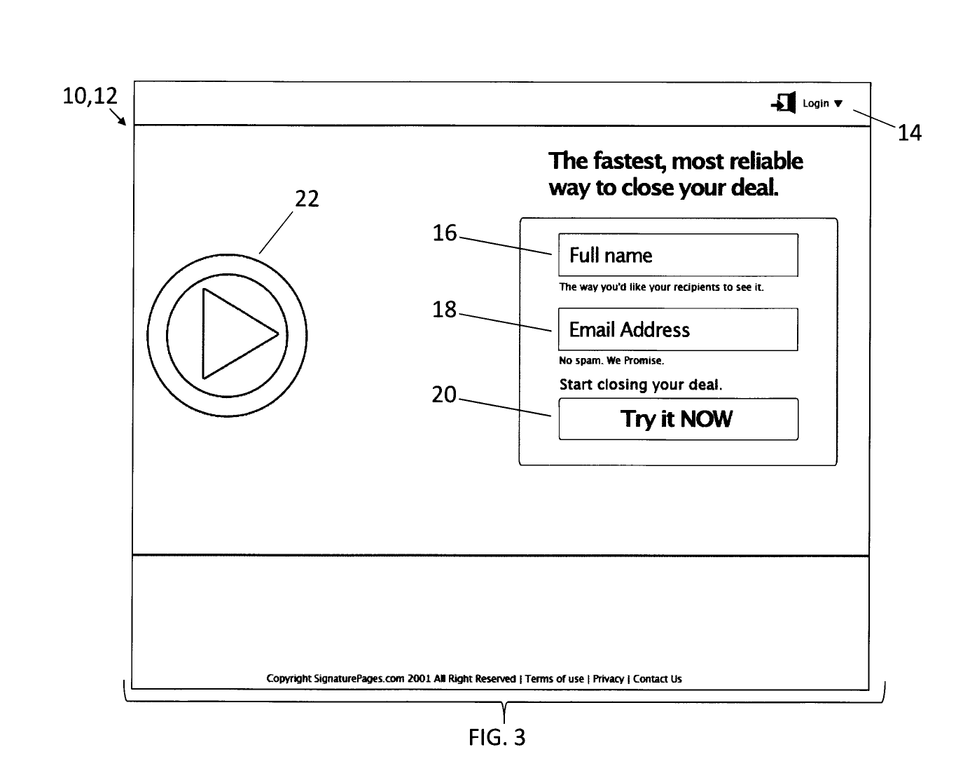

FIG. 3 is a screenshot of a login page 12 of an exemplary signature page management program 10 embodying the present invention. After a user enters the appropriate web address in an internet browser program or accesses the exemplary signature page management program 10 directly, the user may click on the login button 14 and input his user name and password to access the site. If the user does not have a login already, they may enter their user name 16 and e-mail address 18 and a password of their choice and click on the Try it NOW button 20 for a free trial. Additionally, the login page may also include an instructional video 22 introducing the user to the signature page management program 10 as well as guiding him through basic functionalities.

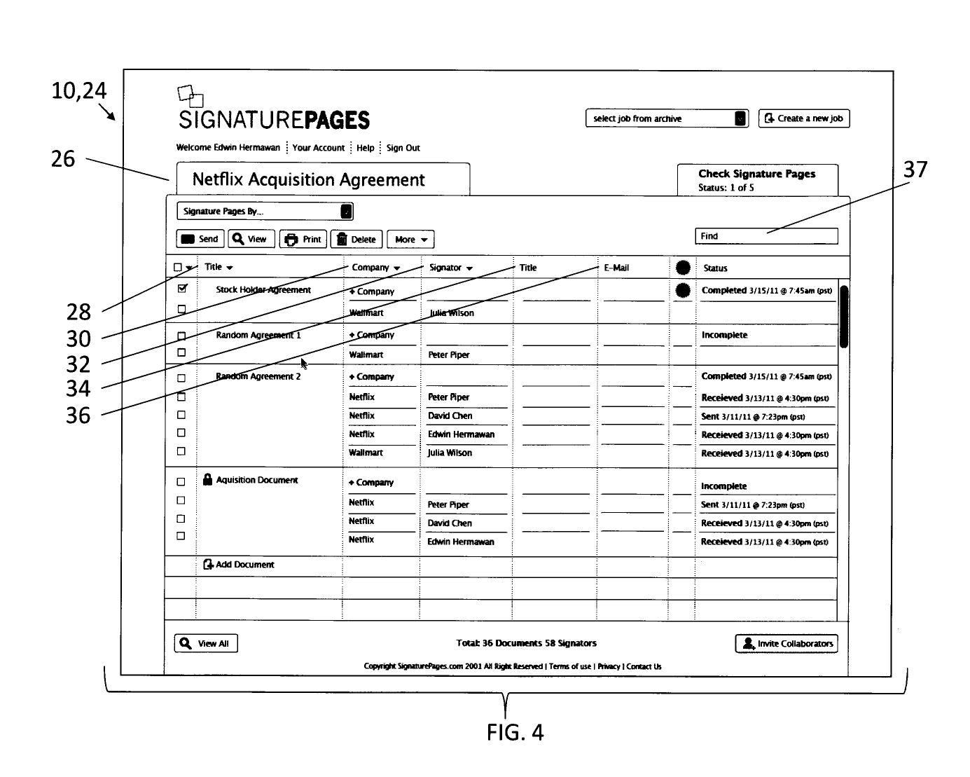

FIG. 4 is a screenshot of an exemplary jobs page 24 of the embodiment of FIG. 1. Upon entering the jobs page 24 the user will be prompted to enter the name of his transaction into the upper left hand tab 26. The main component on the jobs page 24 is the data field in the center of the page. Here, the user may directly type in essential data needed for a signature page. This includes the title of signature page 28, the company name 30, signator name 32, signator title 34, and e-mail address 36. The title of the signature page 28 could also be the same as an agreement identifier. The title of the signature page/agreement identifier 28 is a specific identifier assigned to each agreement to track it from the multitude of agreements. The user may input information for as many signature pages as he would like. For each agreement they may enter in as many companies and signators as he would like as well. Under each column header, the user may arrange the column content alphabetically. The user may also search for specific information by typing a query into the search box 37. When the user is done, the information in the data fields (28, 30, 32, 34 and 36) will be placed into a template to be viewed in the view page 38. The user may also easily search through the multitude of agreements by selecting a specific agreement by selecting a specific piece of data from the data fields (28, 30, 32, 34 and 36). For instance the user could search by selecting a specific company from the company name data field 30, or could search through the e-mail address data field 36 by selecting a specific e-mail address.

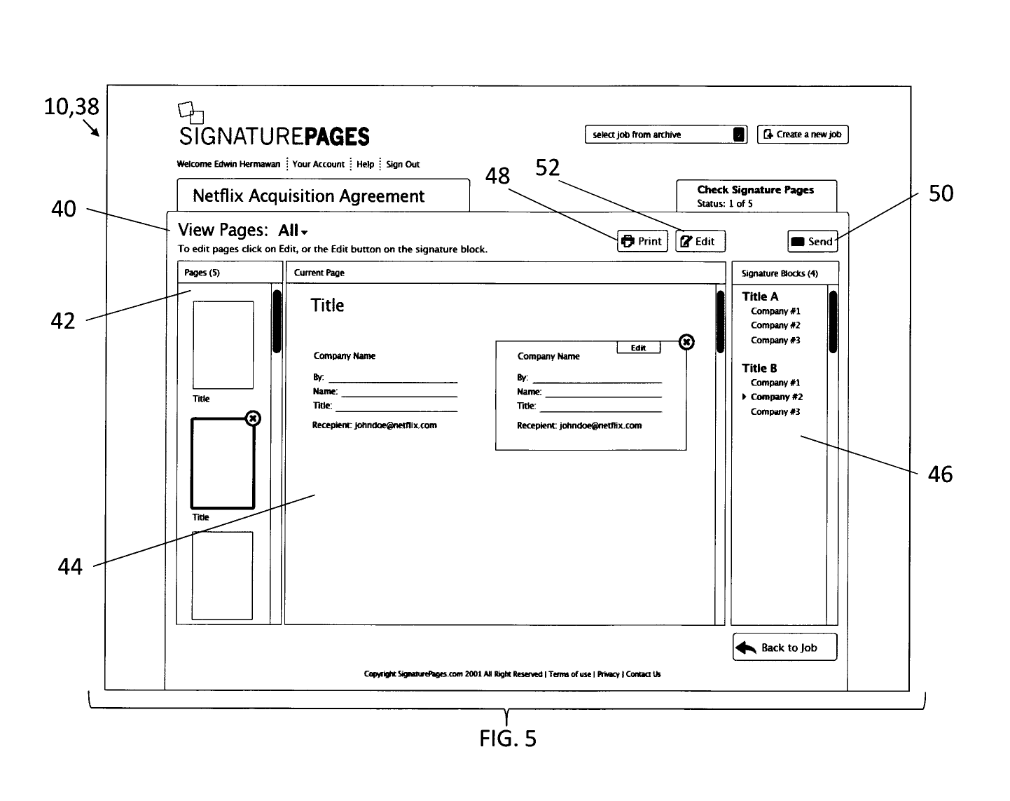

FIG. 5 is a screenshot of an exemplary view page 38 of the embodiment of FIG. 1. After the user has inputted information into the data fields (28, 30, 32, 34 and 36) of the jobs page 24, the program 10 will put the information onto a template signature page to be viewed in the view page 38.

The user may select which signature pages he would like to view by selecting the drop down menu 40 in the upper left hand corner. The user may view all, by company, or by signator. Then, the left hand panel 42 will have resized thumbnails of the signature pages. The central panel 44 may have 100% sized images of the signature pages for ease of viewing. The right hand panel 46 will have a text list of the signature pages and accompanying companies signing each signature page. This list will allow the user to do a quick confirmation that all appropriate companies are listed on the appropriate signature pages.

From the view page 38 the user may print 48 the signature pages to review the signature pages in physical form. The user may send 50 the signature pages if they are satisfied with them. If the user would like to edit the content or formatting of the signature pages they may click the edit button 52 and that will send them into the edit page 54.

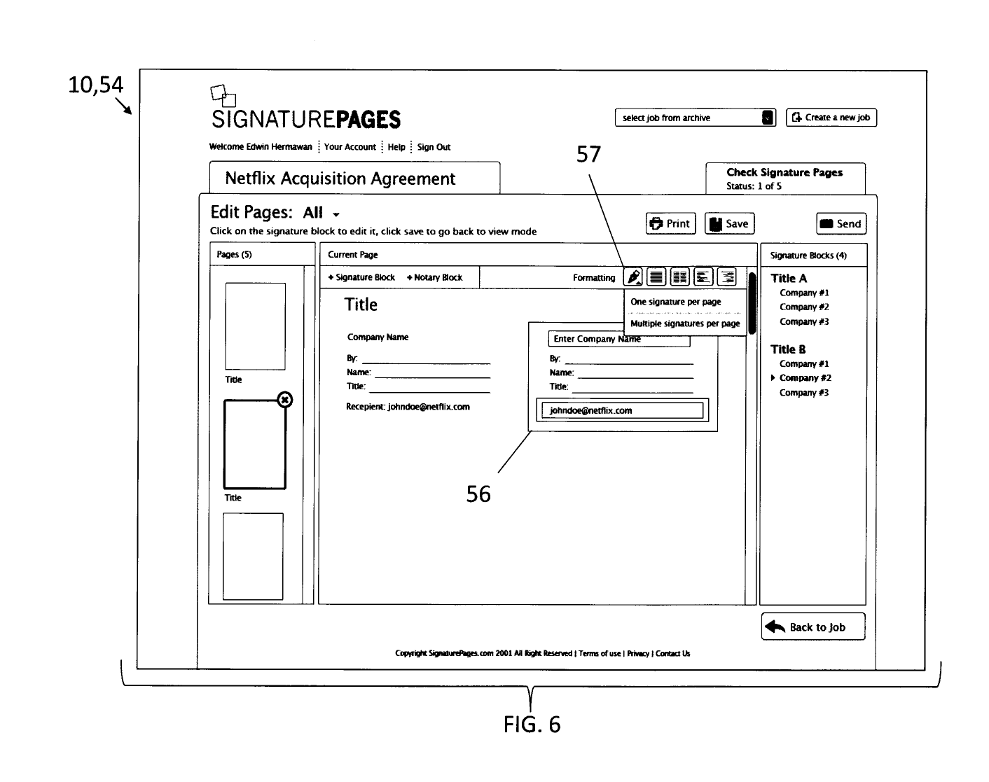

FIG. 6 is a screenshot of an exemplary edit page 54 of the embodiment of FIG. 1. Here, the user may edit any content or formatting for the signature page already shown in FIG. 3. If the user would like to edit the content of the signature page he simply needs to double click on a particular signature block and the fields will then become editable, as shown at 56. Other formatting tools 57 are also available. For example, the user could change the formatting from single to multiple signatures. The user will also be able to change the formatting from a single column to double column layout (and vice-versa), change the formatting from multiple signature blocks per page to only one signature block per page (and vice versa), add a signature block, or also add a notary block. Once the user is satisfied with the content and formatting they may then send off the documents at the send page 58.

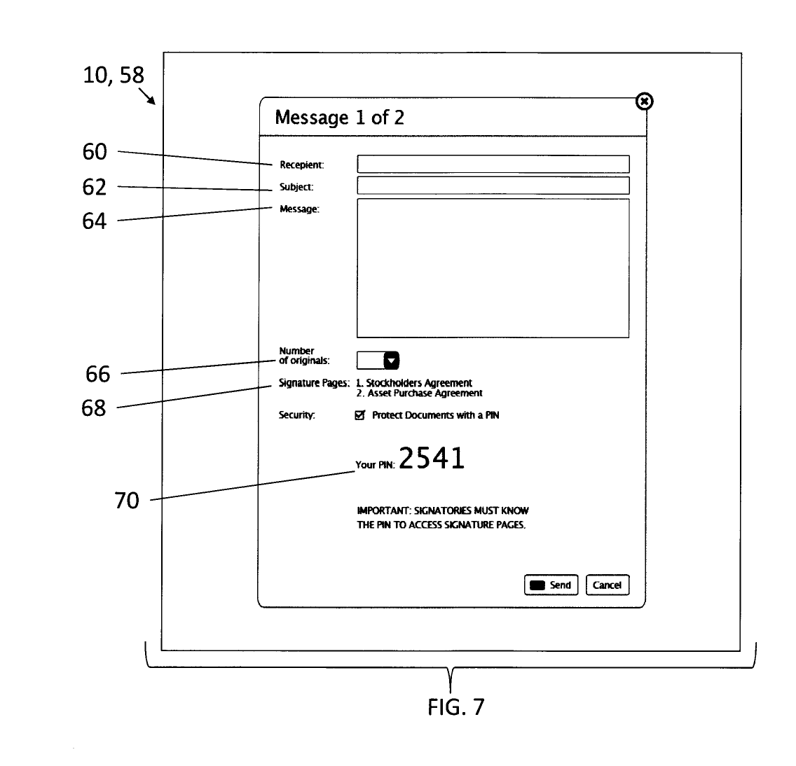

FIG. 7 is a screenshot of an exemplary send page 58 of the embodiment of FIG. 1. Here, the user may send the signature pages to their proper recipients 60. The program 10 will create one message for each recipient 60. If there are multiple recipients 60, there will be multiple messages.

The user may input his own subject line 62 and message 64. The user may also request the number of originals 66. This is useful because multiple parties sometimes request originals. If the user requests multiple originals then the program 10 will send over a corresponding number of copies of each signature page. For example: If the user would like two (2) originals of the Stockholders Agreement the program 10 will send the recipient two (2) copies of the Stockholders Agreement to sign.

The user may then confirm that the recipient is receiving all the appropriate documents by checking the list of signature pages attached at 68. The user may also then password protect the documents. The program 10 may then generate a unique four digit pin 70 that the user will have to tell the recipient 60.

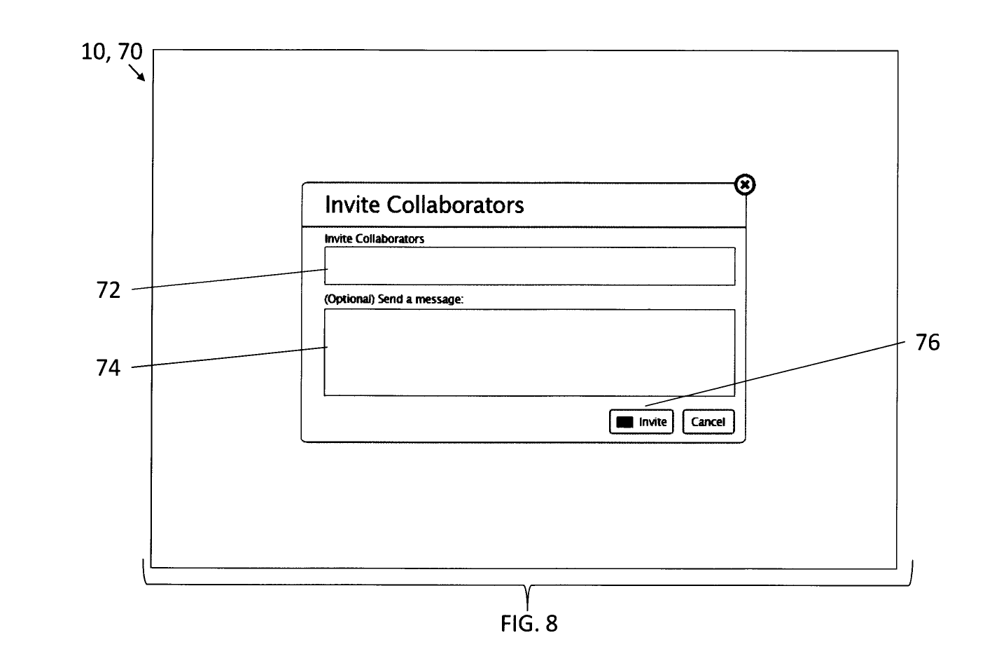

FIG. 8 is a screenshot of an exemplary invite collaborator page 70 of the embodiment of FIG. 1. This function will allow the user to invite a collaborator to add and edit signature pages to a particular transaction. This is most useful when dealing with hedge funds or other parties who are unsure which particular entity or subsidiary will be bound by the documents. This added functionality allows the invited party to enter in the needed information themselves. The user can invite the collaborators by entering in their email address at 72, and may also send an optional message at 74. Clicking the invite button 76 then invites the collaborator to join the process.

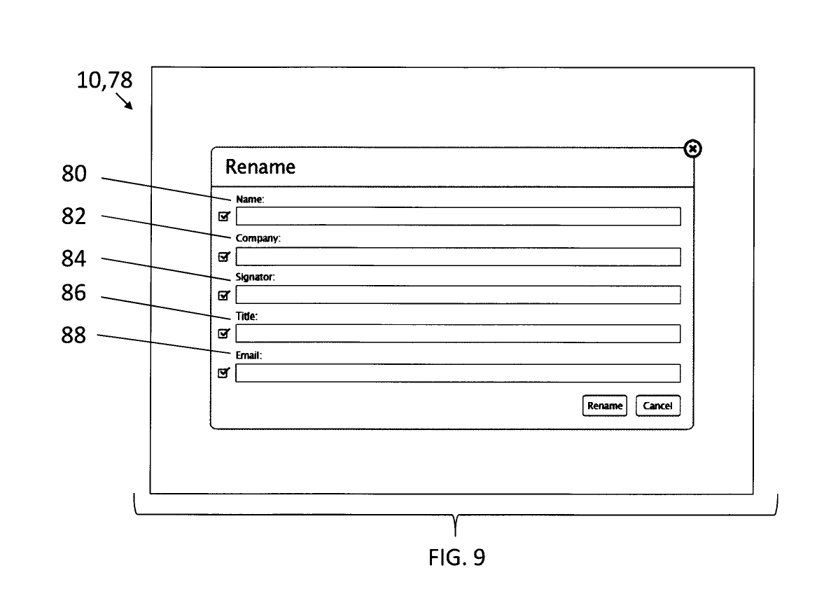

FIG. 9 is a screenshot of an exemplary rename page 78 of the embodiment of FIG. 1. This function allows the user to quickly rename the contact name 80, company name 82, signators 84, titles 86, and e-mail addresses 88. All the user has to do is select the entries he would like to rename and click the rename button.

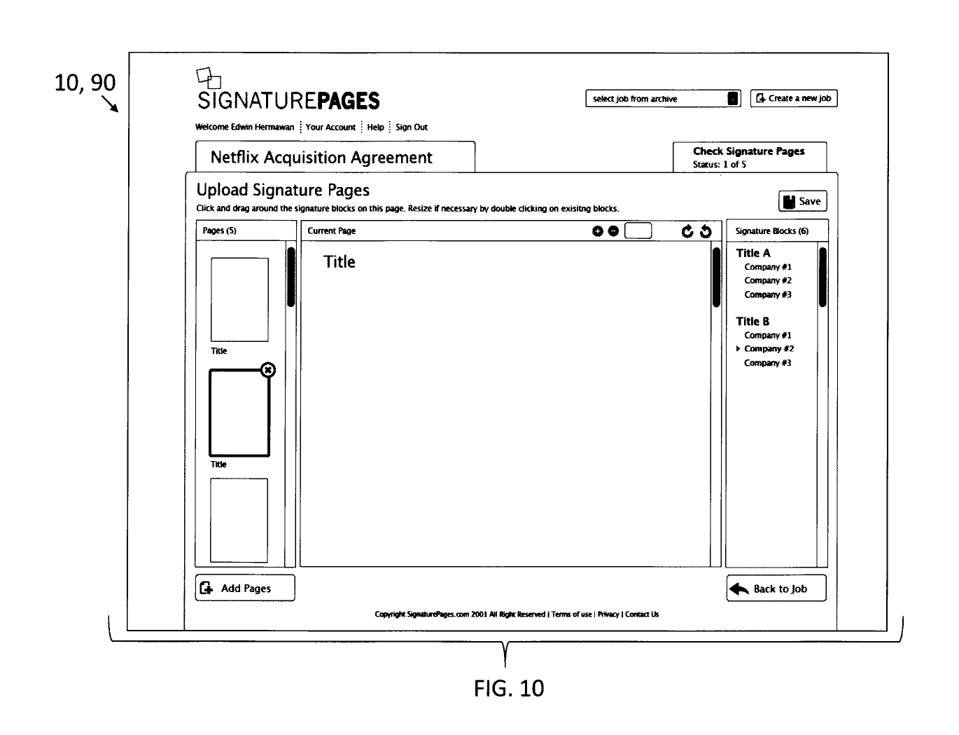

FIG. 10 is a screenshot of an exemplary upload signature page 90 of the embodiment of FIG. 1. If the user has already created their own signature page or pages, they may upload these at the upload signature page 90. Here, the user will tag the signature blocks by drawing a box around each signature block it. Afterwards, the user will be prompted to enter in all appropriate information. The information inputted will then be reflected in the data field in the SP jobs page but will not be editable.

Alternatively, the user will be able to upload completed signature pages onto the system in case the recipient has sent the user the executed documents instead of uploading them onto the application.

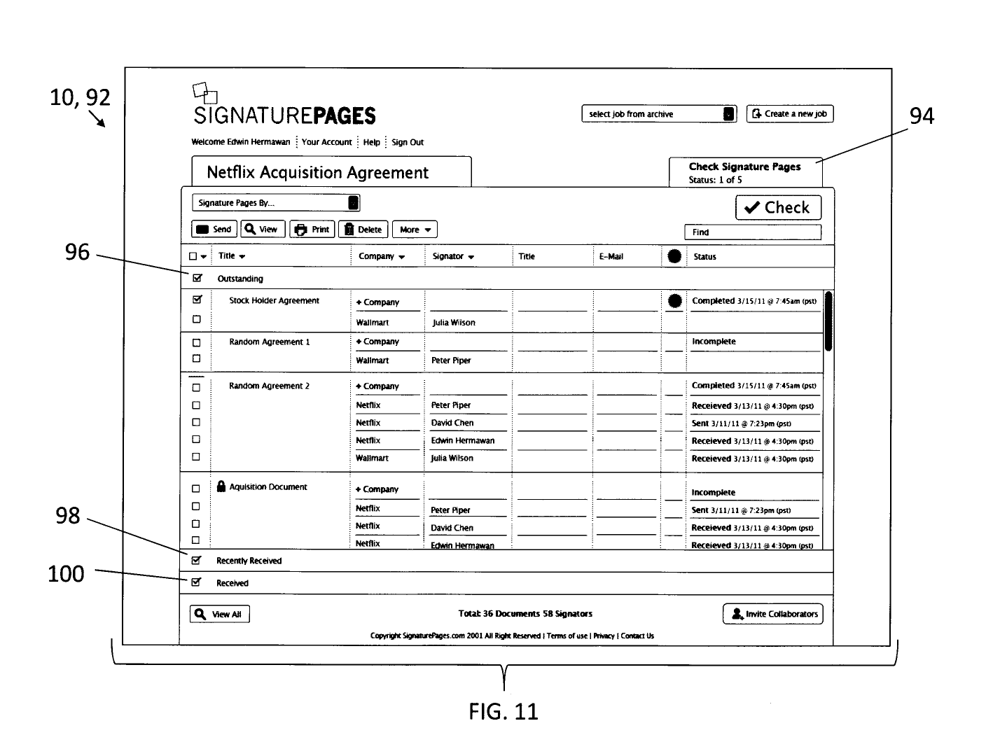

FIG. 11 is a screenshot of an exemplary check signature page 92 of the embodiment of FIG. 1. The check signature pages tab 94 in the upper right hand corner tells the user quickly how many signature pages have come in. The layout of the page 92 may be generally the same as the jobs page 24 with certain key differences. For instance, the data field in the center is laid out in an accordion fashion and arranged by signature pages outstanding 96, signature pages recently received 98, and signature pages received 100. This allows the user to quickly know what signature pages he is still waiting on and which ones he just got in.

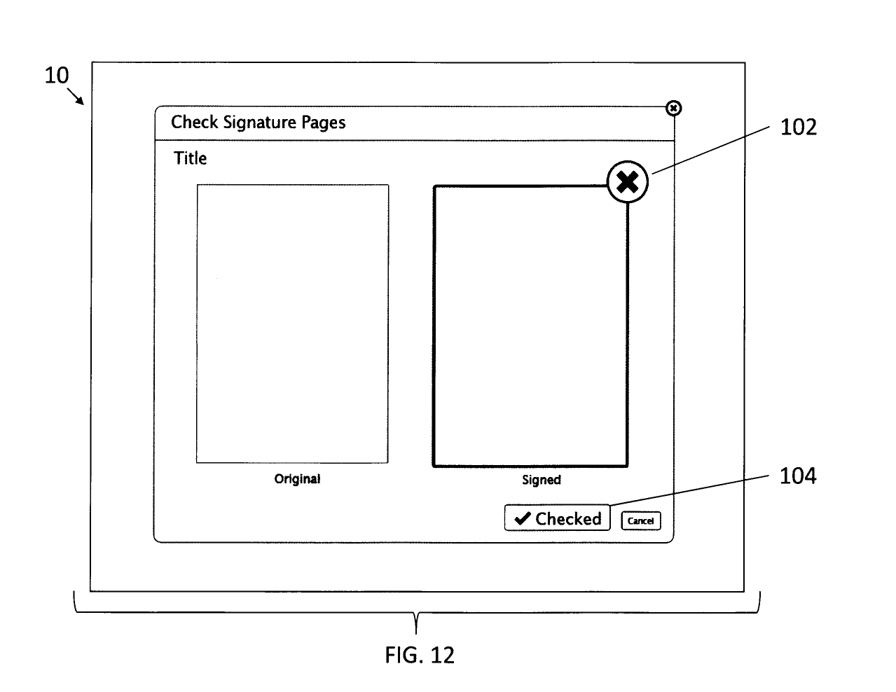

FIG. 12 is a screenshot of an exemplary check page 102 of the embodiment of FIG. 1. This page 102 allows the user to select executed signature pages and do a visual confirmation that they have been signed. If there is a problem with a particular signature, the user can click on the X 102 in the upper right of the executed page and delete the page. If the user is satisfied with the documents he can click checked 104 and the status of the document will read checked. This is particularly helpful to prevent the user from having to check over items he has already double checked.

Additionally, the user can download all the executed pages. The downloaded file may contain either one pdf with all executed pages or individual pdfs of signature pages for each document.

Additionally, a separate tagging beyond the agreement identifier may be used on each signature page to facilitate the signature page management program 10 for identifying and organizing. The tagging may be a barcode or unique identifier at the bottom of every signature page which is easily recognizable by the signature page management program 10. When a signature page gets uploaded, the tagging is read and then corresponds to a specific agreement. As can be seen by one skilled in the art there exists a variety of methods and ways to tag or electronically relate various signature pages to their respective agreements.

Although several embodiments have been described in detail for purposes of illustration, various modifications may be made to each without departing from the scope and spirit of the invention. Accordingly, the invention is not to be limited, except as by the appended claims.

What is claimed is:

1. A computer implemented method of managing signatures, comprising the steps of:
receiving, via a computing device, signatory information from a user related to a signatory and an agreement identifier, where the agreement identifier identifies a specific agreement from a plurality of agreements;
sending, via the computing device, a signature page to the signatory, where the signature page is associated with the specific agreement by the agreement identifier;
receiving, via the computing device, the signature page comprising a signature of the signatory; and
displaying, via the computing device, a status of the specific agreement, the status comprising an indication of the signature page sent, an indication of the signature page received, an incompletion of the signature of the signatory or a completion of the signature of the signatory.

2. The computer implemented method of claim 1, wherein the signature page and specific agreement comprise separate documents.

3. The computer implemented method of claim 2, further comprising the step of verifying, via the computing device, the signature of the signatory on the signature page.

4. The computer implemented method of claim 3, wherein the step of verifying the signature of the signatory on the signature page comprises visually verifying the signature by the user and further including the step of storing, via the computing device, a positive or negative verification of the signature of the signatory on the signature page.

5. The computer implemented method of claim 1, further including the step of inviting, via the computing device, a collaborator associated with the at least one signatory.

6. The computer implemented method of claim 5, further including the step of allowing, via the computing device, the collaborator to identify a specific individual associated with the signatory.

7. The computer implemented method of claim 1, wherein the computing device comprises a webpage connected to the Internet.

8. The computer implemented method of claim 1, wherein the step of sending and receiving of the signature page via the computing device comprises email.

9. The computer implemented method of claim 1, wherein the signatory information comprises a specific individual associated with the signatory and a company name associated with the signatory.

10. The computer implemented method of claim 1, wherein the signatory comprises a plurality of signatories.

11. The computer implemented method of claim 1, wherein the signature page comprises a plurality of signature pages each associated with the specific agreement through the agreement identifier.

12. The computer implemented method of claim 1, further including the step of generating, via the computing device, the signature page from a premade template and the signatory information.

13. The computer implemented method of claim 1, further including the step of uploading, via the computing device, the signature page comprising a premade signature page.

14. The computer implemented method of claim 1, wherein the signature of the signatory comprises a physical signature.

15. The computer implemented method of claim 1, further including the step of organizing, via the computing device, the specific agreement from the plurality of agreements based upon the agreement identifier, a company name or the signatory.

16. A computer implemented method of managing signatures, comprising the steps of:
receiving, via a computing device, signatory information from a user related to at least one signatory and an agreement identifier, where the agreement identifier identifies a specific agreement from a plurality of agreements;
generating, via the computing device, a signature page from a premade template and the signatory information, where the signature page and the specific agreement comprise separate documents;
sending, via the computing device, the signature page to the at least one signatory, where the signature page is associated with the specific agreement through the agreement identifier; and
receiving, via the computing device, the signature page comprising a physical signature of the at least one signatory.

17. The computer implemented method of claim 16, further comprising the step of verifying, via the computing device, the physical signature of the at least one signatory on the signature page.

18. The computer implemented method of claim 17, wherein the step of verifying the physical signature of the at least one signatory on the signature page comprises visually verifying the physical signature by the user and further including the step of storing, via the computing device, a positive or negative verification of the physical signature of the at least one signatory on the signature page.

19. The computer implemented method of claim 16, further including the step of displaying, via the computing device, a status of the specific agreement, the status comprising an indication of the signature page sent, an indication of the signature page received, an incompletion of the physical signature of the at least one signatory or a completion of the physical signature of the at least one signatory.

20. The computer implemented method of claim 19, further including the step of organizing, via the computing device, the specific agreement from the plurality of agreements based upon the agreement identifier, a company name or the at least one signatory.

21. The computer implemented method of claim 16, further including the step of inviting, via the computing device, a collaborator associated with the at least one signatory and further including the step of allowing, via the computing device, the collaborator to identify a specific individual associated with the at least one signatory.

22. A computer implemented method of managing signatures, comprising the steps of:
receiving, via a computing device, signatory information from a user related to at least one signatory and an agreement identifier, where the agreement identifier identifies a specific agreement from a plurality of agreements;
sending, via the computing device, a signature page to the at least one signatory, where the signature page is associated with the specific agreement through the agreement identifier;
receiving, via the computing device, the signature page comprising a signature of the at least one signatory;
verifying, via the computing device, the signature of the at least one signatory on the signature page by visually verifying the signature by the user; and
storing, via the computing device, a positive or negative verification of the signature of the at least one signatory on the signature page.

23. The computer implemented method of claim 22, further including the step of inviting, via the computing device, a collaborator associated with the at least one signatory.

24. The computer implemented method of claim 23, further including the step of allowing, via the computing device, the collaborator to identify a specific individual associated with the at least one signatory.

25. The computer implemented method of claim 22, further including the step of generating, via the computing device, the signature page from a premade template and the signatory information.

26. The computer implemented method of claim 22, further including the step of uploading, via the computing device, the signature page comprising a premade signature page.

27. The computer implemented method of claim 22, wherein the signature of the at least one signatory comprises a physical signature.

28. The computer implemented method of claim 22, further including the step of displaying, via the computing device, a status of the specific agreement, the status comprising an indication of the signature page sent, an indication of the signature page received, an incompletion of the signature of the at least one signatory or a completion of the signature of the at least one signatory.

29. The computer implemented method of claim 28, further including the step of organizing, via the computing device, the specific agreement from the plurality of agreements based upon the agreement identifier, a company name or the at least one signatory.
